(19) United States
(12) Patent Application Publication
(10) Pub. No.: US 2004/0140657 A1
(43) Pub. Date: Jul. 22, 2004

(54) Air-bag

(76) Inventor: Shyam S.V. Kuppurathanam, Ogden, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/348,199

(22) Filed: Jan. 21, 2003

(51) Int. Cl. B60R 21/16

(52) U.S. Cl. 280/743.1

(57) ABSTRACT

A method of sealing an air-bag (1) is disclosed, the air-bag having a gas flow duct (4) and a plurality of inflatable cells (5), with each cell (5) having a mouth (6) fluidly connecting the cells (5) to the gas flow duct (4). The method involves inserting a sleeve or “parison” of deformable sealant material (8) into the gas flow duct (4), and then blowing a propellant gas into the sleeve (8) so that the sleeve (8) inflates to form a bubble (12) of sealant material in the region of at least one mouth (6) of a cell (5). The propellant gas is blown into the sleeve (8) until at least the or each said bubble (12) bursts, so as to form a sealant layer on the interior of the air-bag (1) in the region of the respective mouth (6).

THE PRESENT INVENTION relates to an air-bag and, more particularly, relates to a method of sealing an air-bag.

The method of the present invention is particularly suited for use during the manufacture of an air-bag which, when inflated, is intended to be located between the head or body of the driver or front-seat occupant of a motor vehicle and the adjacent window. Such an air-bag is commonly known as a “side-curtain” and may be adapted to be inflated in the event that a side impact or roll-over situation should occur. A side-curtain may extend adjacent to the head of the driver or front-seat occupant of the motor vehicle, or may extend from the front of the vehicle to the rear of the motor vehicle, along the side of the vehicle, in order to provide protection, not only for the driver and front seat occupant of the motor vehicle, but also for an occupant of the rear-seat of the vehicle.

A side-curtain must be deployed extremely rapidly if it is to provide adequate protection in the event that a side impact or roll-over situation should occur, and consequently the side-curtain is inflated by injecting a large quantity of gas into the side-curtain very rapidly. The inflation of the side-curtain is consequently violent, and the fabric of the side-curtain may stretch at certain points.

In order to improve the gas-tightness of the fabric that makes up an air-bag, it is conventional to provide the fabric with a coating of a sealant material such as a silicone rubber. In certain air-bags, such as air-bags intended to provide protection for the driver or front-seat occupant of the vehicle in the event that a front impact should occur, the air-bag is initially fabricated with the coating provided on the exterior of the air-bag, and then the air-bag is turned inside-out before being installed in the motor vehicle so that the coating is then on the interior of the air-bag. In the event that the air-bag is inflated in a crash situation, the gas that is injected into the air-bag tends to urge the coating into firm contact with the yarns constituting the fabric from which the air-bag is made, ensuring that any small gap that might exist between the yarns is sealed, consequently ensuring the integrity and gas-tightness of the air-bag. This is important, because in many instances an inert gas of low atomic weight is used to inflate the air-bag, and such a gas can easily pass through very small interstices between adjacent yarns. The coating also protects the fabric from the hot gas that may be present in the air-bag as it is being inflated. The strength of the fabric may be reduced if the fabric is not protected from the hot gases.

In the case of a side-curtain, however, the air-bag is of a complex form, generally comprising a gas-flow duct formed along the top of the curtain, and a plurality of inflatable cells arranged below the gas-flow duct and in fluid communication with the gas-flow duct. The inflatable cells are separated from one another by seams. Consequently, a side-curtain cannot readily be turned inside-out. Thus in many side-curtains the coating is applied to the exterior of the air-bag with the result that the pressure of gas present within the air-bag, when it is inflated, tends to dislodge the coating from the exterior of the air-bag, rather than tending to press the coating more firmly into the interstices of the fabric. Since, as the bag is inflated, the fabric from which the bag is made may stretch, especially in areas where high stresses are applied to the air-bag, the exterior coating to become dislodged from the fabric in the region in where the stretching occurs. Also, the lack of an internal coating means that the fabric of the air-bag will not be protected from the hot gases.

The present invention seeks to provide an improved method for sealing an air-bag, and an air-bag sealed according to that method.

According to the present invention, there is provided a method of sealing an air-bag having a gas inlet aperture and an inflatable chamber, the method comprising the steps of:

inserting a sleeve of deformable sealant material into the air-bag through said gas inlet aperture,

blowing a propellant gas into the sleeve such that the sleeve inflates to form a bubble of sealant material within said inflatable chamber, and

continuing to blow said propellant gas into the sleeve at least until said bubble bursts to form a sealant layer on at least part of the interior of the air-bag.

Advantageously, the air-bag has a gas flow duct and a plurality of inflatable cells, each cell having a mouth fluidly connecting the cell to the gas flow duct, and wherein the method comprises the steps of:

inserting said sleeve of deformable sealant material into the gas flow duct,

blowing said propellant gas into the sleeve such that the sleeve inflates to form a bubble of sealant material in the region of at least one said mouth, and

continuing to blow said propellant gas into the sleeve at least until the or each said bubble bursts to form a sealant layer on the interior of the airbag in the region of the or each respective mouth.

Preferably, the step of blowing propellant gas into the sleeve causes the sleeve to inflate within the gas flow duct to form a sealant layer on the interior of the gas flow duct.

Advantageously, the propellant gas is water vapour.

Conveniently, the gas is heated.

Preferably, the propellant gas is produced by a gas generator upon inflation of the air-bag in a crash situation.

Advantageously, the sleeve is inserted into the gas flow duct on a mandrel.

Conveniently, said blowing step consists of injecting said propellant gas through the mandrel.

Preferably, the mandrel is provided with one or more gas outlets and wherein the method comprises a step of locating the or each gas outlet adjacent a respective mouth to be sealed when the mandrel is inserted into the gas flow duct.

Advantageously, the mandrel is provided with one said gas outlet, the method comprising the step of sequentially locating the gas outlet adjacent a selected mouths to be sealed.

Conveniently, the step of selectively locating is performed as the mandrel is withdrawn from the sleeve.

Preferably, the sleeve is pre-weakened in predetermined regions to be burst.

Advantageously, the sleeve is of polyurethane material.

Conveniently, the sleeve is of latex material.

Preferably, the sleeve is of nylon material.

Advantageously, the sleeve is of polyester material.

Conveniently, the sleeve is of silicone material.

Preferably, the sealant material has a thermal conductivity of 0.2 to 0.5 W/mK.

Advantageously, the sealant material has a thermal conductivity of 0.25 W/mK.

Conveniently, the sealant material has a heat capacity of 0.95 to 1.05 J/gC°.

Preferably, the sealing material has a heat capacity of 1.0 J/gC°.

Advantageously, the method further comprises the step of heat curing the air-bag after the or each said bubble has burst.

According to a further aspect of the present invention, there is provided an air-bag when sealed by a method as defined above.

In order that the invention may be more readily understood, and so that further features thereof may be appreciated, embodiments of the invention will now be described, by way of example, with reference to the accompanying drawings in which:—

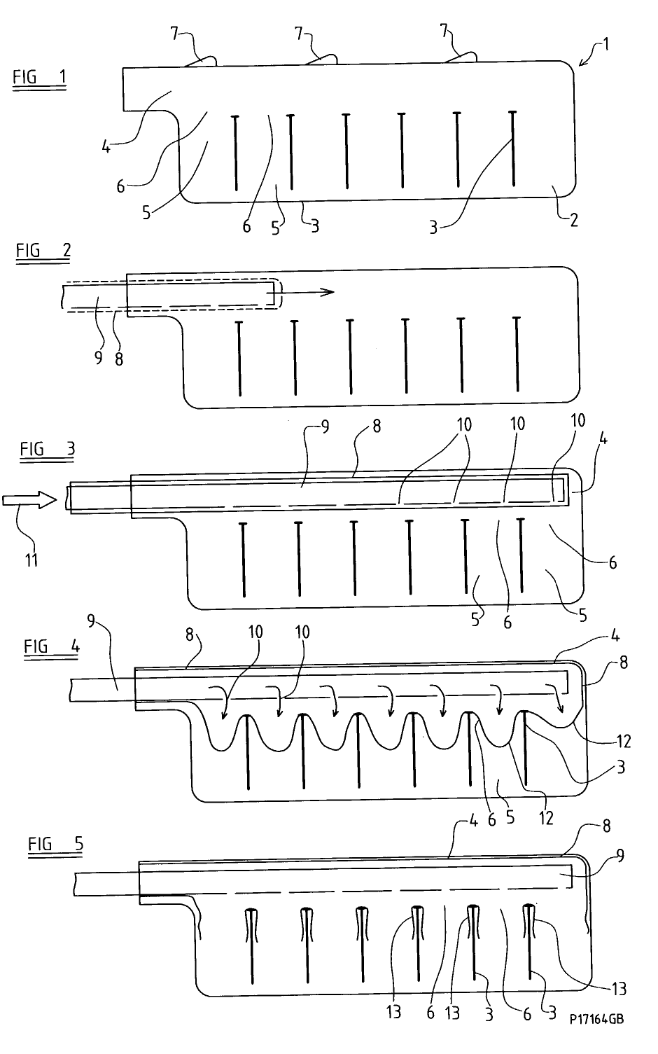

FIG. 1 is a diagrammatic view of an air-bag of the side-curtain type, to be sealed according to the method of the present invention;

FIG. 2 is a view corresponding generally to that of FIG. 1, illustrating a first step of the sealing method of the present invention;

FIG. 3 is a view corresponding generally to that of FIG. 2, illustrating a subsequent step of the method;

FIG. 4 is a view corresponding generally to that of FIG. 3, illustrating a further step of the method;

FIG. 5 is a view corresponding generally to that of FIG. 4, illustrating the air-bag during a subsequent stage of the method;

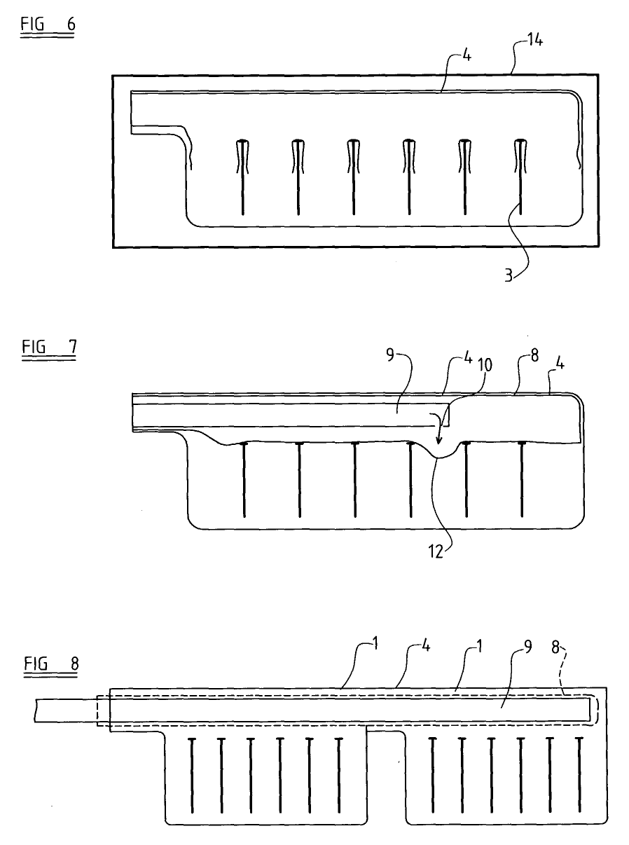

FIG. 6 is a view corresponding generally to that of FIG. 5, illustrating the air-bag during a subsequent step of the method;

FIG. 7 is a view corresponding generally to that of FIG. 4, illustrating an alternative intermediate step of the sealing method; and

FIG. 8 is a diagrammatic view of a pair of air-bags being sealed simultaneously.

Referring initially to FIG. 1 of the accompanying drawings, an air-bag 1 which is in the form of a side-curtain, is formed from two super-imposed layers of fabric 2 inter-connected by a plurality of scams 3 in selected areas of the upper and lower layers of fabric forming the air-bag 1. The seams 3 define a gas-flow duct 4 extending substantially parallel with the upper edge of the bag, and also define a plurality of substantially vertical parallel spaced cells 5, each of which communicate, by means of a mouth 6, with the gas-flow duct 4. The air-bag 1 is provided with a plurality of protruding lugs 7 which protrude from the upper edge of the air-bag 1 adjacent the gas-flow duct 4, by means of which the air-bag 1 may be mounted in position in a motor vehicle.

The air-bag, as thus far described, is formed from an appropriate fabric which may, for example, be a conventional fabric woven from yarns or fibres made from polyamide, polyester, polyvinyl chloride or some other appropriate synthetic material, although it is envisaged that the fabric may be knitted or non-woven. The seams 3 may be formed by stitching together the super-imposed layers of fabric, although it is preferred that the seams are fabricated by weaving together threads from the upper and lower layers of fabric in selected regions to form the seams, generally as described in WO90/09295, with a so-called one-piece weaving technique.

In order to seal the interior of the air-bag 1, a sleeve or “parison” 8 of sealant material is then inserted, as illustrated in FIG. 2, into the gas-flow duct 4 of the air-bag 1, on a hollow air-injecting mandrel 9. The sealant material can be either polyurethane, latex, nylon, polyester or silicone, and the sleeve 8 of that material is provided in a substantially plastic state.

In order to facilitate insertion of the mandrel 9 and the sleeve 8, the gas-flow passage 4 of the air-bag may be gently inflated or held in an open position by an appropriate mechanical arrangement. For example, vacuum suction could be used to pull apart opposite sides of the exterior of the air-bag defining the gas-flow passage, thus separating the layers of fabric that form the gas-flow passage 4 and facilitating the easy insertion of the mandrel and sleeve or “parison” 8 into the gas-flow passage 4.

As illustrated in FIG. 3, the mandrel is provided with a plurality of outlet apertures 10 spaced along its length. The mandrel 9 is inserted into the gas-flow passage 4 such that each outlet aperture 10 is located above and substantially adjacent a respective mouth of an inflatable cell 5.

Once the mandrel 9 and sleeve or “parison” 8 of sealant material have been inserted into the gas-flow passage 4, to occupy the position illustrated in FIG. 3, hot water vapour or other propellant gas is injected (as illustrated by arrow 11) through the hollow mandrel 9 so as to flow out through the outlet apertures 10 and inflate the sleeve or “parison” 8. An intermediate stage during inflation of the sleeve or “parison” 8 is illustrated in FIG. 4, from which it will be seen that the sleeve or “parison” 8 has become inflated so that it bears against the inner surface of the gas-flow duct 4 and against the seams 3 between the mouths 6 of the inflatable cells 5. However, the propellant gas is injected into the mandrel 9 under high pressure so that the gas flow out through the apertures 10 with considerable force, which causes the sleeve or “parison” 8 to distend in the region of each mouth 6, to form a bubble 12 extending partway into each cell 5.

The propellant gas continues to be injected through the mandrel 9 until each bubble 12 bursts. Because of the high pressure at which the propellant gas is injected into the mandrel 9, each bubble 12 bursts with considerable force. It has been found that the bubbles typically burst when the gas pressure within the sleeve is between 20 and 120 kPa (depending upon the distance between the inflator and the bubble in question). The bubbles therefore burst with such a considerable force that the sealant material of the sleeve or “parison” 8 becomes pressed intimately against the uppermost region of each seam 3, generally as illustrated in FIG. 5. It will be seen that the upper region of the seams 3, where they terminate adjacent the gas-flow duct 4, are hence covered with a region 13 of sealant material. It has been found that, providing the sealant material used is suitably deformable but not excessively flexible, the stretched-out regions which cover the seams upon rupture of the bubbles do not subsequently shrink back so as to withdraw from the cells 5.

The mandrel 9 is then withdrawn from the gas-flow duct 4 and the resulting air-bag is placed within an oven 14 where it is heat cured at an elevated temperature, in order to adhere the sealant material of the sleeve to the fabric of the air-bag. It should therefore be appreciated that the resulting air-bag has a layer of sealant material adhered to the innermost surface of the fabric over the entire extent of the gas-flow duct 4, and over the upper regions of the seams 3, where they meet the gas-flow duct 4. These are the regions of the interior of the air-bag which are most vulnerable to damage during inflation of the air-bag in a crash situation.

It will therefore be appreciated that the above-described method serves to seal the seams 3 adjacent each mouth 6 defining the opening of the cells 5. However, it is proposed that an alternative method within the scope of the present invention may permit sealing of only selected cells 5. An intermediate step of such a method is illustrated schematically in FIG. 7. At this stage of the procedure, the sleeve 8 of sealant material has been fully inserted into the gas-flow duct 4 by the mandrel 9, and the mandrel 9 is illustrated being withdrawn from the gas-flow duct 4. The mandrel 9 used in this variant of the method is provided with only one outlet aperture 10 which is located in the region of the end of the mandrel 9 which is inserted furthest into the gas-flow duct 4.

During withdrawal of the mandrel 9 from the gas-flow duct 4, the mandrel can be held at pre-selected positions such that the outlet aperture 10 is located substantially adjacent selected mouths 6, and whilst held in such a position, the propellant gas is injected into the mandrel 9. In this way, a bubble 12 can be inflated either in each mouth 6 in turn, or only in selected mouths 6. Of course, the propellant gas continues to be injected into the mandrel until such time as the or each bubble 12 bursts in the manner as described above. This method allows a standard air-bag in the form of an inflatable curtain to be tailor made such that only certain cells 5 are open to the gas flow duct whilst after cells remain sealed, so that they will not inflate when, during deployment of the inflatable curtain, gas is injected into the gas flow duct. This could be advantageous where, for example, a stock supply of air-bags are to be given particular inflation characteristics for use in different models of vehicle.

Turning now to consider FIG. 8, a pair of air-bags 1 are illustrated in a condition in which they are defined between adjacent regions of the same upper and lower layers of fabric material. It is known to provide a number of air-bags 1 in this way, particularly where the air-bags are formed by weaving together threads from the upper and lower layers of fabric in selected regions generally as described in WO90/09295. In this way, a large number of air-bags 1 can be produced as a strip, or on a roll, and can then be subsequently cut in order to separate the air-bags from one another.

As illustrated in FIG. 8, before cutting the two air-bags 1 from one another, a long sleeve or “parison” 8 of sealant material is inserted into the gas-flow passage 4 extending across the top of both air-bags, on a long mandrel 9. It will be appreciated that subsequent steps of the sealing process are substantially identical to those described above. This method allows a number of air-bags to be sealed in a single step, after which the mandrel 9 can be withdrawn from all of the air-bags and the air-bags can then be cut apart from one another to form separate, distinct air-bags with sealant material provided on the interior surface of the fabric.

Whilst the methods described above involve the injection of a propellant gas through a mandrel 9 as a fabrication step of the air-bag before the air-bag is installed on a motor vehicle, it is also envisaged that the air-bag could be folded and mounted within a motor vehicle with the sleeve 8 of sealant material inserted into the gas-flow passage 4, but such that the sleeve 8 has not been inflated. For example, it is envisaged that in a crash situation the hot gas produced by a gas generator provided as part of an air-bag unit installed on a motor vehicle could be injected down the sleeve 8 in order to inflate the sleeve 8 against the interior of the gas-flow duct 4, to distend the sleeve 8 into the bubbles 12, and to burst the bubbles 12 whereafter the gas would continue to flow in order to inflate the air-bag. In this way, the air-bag is initially provided in an unsealed configuration, but the air-bag becomes sealed during its inflation in a crash situation. Of course, in this type of arrangement, it is not possible to heat cure the sealant material, but it has been found that the regions of sealant material 3 which are urged against the seams 3 when the bubbles 12 burst, are sufficiently held in place during inflation of the air-bag to ensure sufficient sealing during inflation of the air-bag.

It is envisaged that in any of the variants of the method described above, the sleeve or “parison” 8 of sealant material could be provided with pre-weakened regions in order to facilitate proper bursting of the distended bubbles 12 during injection of the propellant gas into the sleeve or “parison” 8. These pre-weakened portions could be provided at radial positions all around the sleeve or “parison” 8 or in positions to be located only substantially above respective inflatable cells 5. If the pre-weakened portions are provided all around the sleeve or “parison” 8, then it will be appreciated that only those pre-weakened regions which become located above inflatable cells 5 upon insertion into the gas-flow duct 4 will be allowed to rupture during inflation of the propellant gas, because any pre-weakened regions which are not located above an inflatable cell, will simply be inflated against the inner wall of the gas-flow duct, and will not be allowed to distend into a bubble.

It has been found that the sealant material of the sleeve 8 must have a low thermal conductivity in order to protect the fabric of the air-bag, but also must have a higher elasticity than the fabric of the air-bag. The preferred range for the thermal conductivity of the sealant material is 0.20-0.50 W/mK (Watt per metre Kelvin), and the most preferred value for the thermal conductivity is 0.25 W/mK. The preferred range of heat capacity for the sealant material is 0.95-1.0 J/gC° (dual per gram centigrade), whilst the most preferred value for the heat capacity of the material is 1 J/gC°.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of sealing an air-bag having a gas inlet aperture and an inflatable chamber, the method comprising the steps of:
inserting a sleeve of deformable sealant material into the air-bag through said gas inlet aperture,
blowing a propellant gas into the sleeve such that the sleeve inflates to form a bubble of sealant material within said inflatable chamber, and
continuing to blow said propellant gas into the sleeve at least until said bubble bursts to form a sealant layer on at least part of the interior of the air-bag.

2. A method according to claim 1, wherein the air-bag has a gas flow duct and a plurality of inflatable cells, each cell having a mouth fluidly connecting the cell to the gas flow duct, and wherein the method comprises the steps of:
inserting said sleeve of deformable sealant material into the gas flow duct,
blowing said propellant gas into the sleeve such that the sleeve inflates to form a bubble of sealant material in the region of at least one said mouth, and
continuing to blow said propellant gas into the sleeve at least until the or each said bubble bursts to form a sealant layer on the interior of the airbag in the region of the or each respective mouth.

3. A method according to claim 2, wherein the step of blowing propellant gas into the sleeve causes the sleeve to inflate within the gas flow duct to form a sealant layer on the interior of the gas flow duct.

4. A method according to claim 1, wherein the propellant gas is water vapour.

5. A method according to claim 1, wherein the gas is heated.

6. A method according to claim 1, wherein the propellant gas is produced by a gas generator upon inflation of the air-bag in a crash situation.

7. A method according to claim 1, wherein the sleeve is inserted into the air-bag on a mandrel.

8. A method according to claim 7, wherein said blowing step consists of injecting said propellant gas through the mandrel.

9. A method according to claim 8, wherein the mandrel is provided with one or more gas outlets and wherein the method comprises a step of locating the or each gas outlet adjacent a respective mouth to be sealed when the mandrel is inserted into the gas flow duct.

10. A method according to claim 9, wherein the mandrel is provided with one said gas outlet, the method comprising the step of sequentially locating the gas outlet adjacent selected mouths to be sealed.

11. A method according to claim 10, wherein said step of selectively locating is performed as the mandrel is withdrawn from the sleeve.

12. A method according to claim 1, wherein the sleeve is pre-weakened in predetermined regions to be burst.

13. A method according to claim 1, wherein the sleeve is of polyurethane material.

14. A method according to claim 1, wherein the sleeve is of latex material.

15. A method according to claim 1, wherein the sleeve is of nylon material.

16. A method according to claim 1, wherein the sleeve is of polyester material.

17. A method according to claim 1, wherein the sleeve is of silicone material.

18. A method according to claim 1, wherein the sealant material has a thermal conductivity of 0.2 to 0.5 W/mK.

19. A method according to claim 18, wherein the sealant material has a thermal conductivity of 0.25 W/mK.

20. A method according to claim 1, wherein the sealant material has a heat capacity of 0.95 to 1.05 J/gC°.

21. A method according to claim 20, wherein the sealant material has a heat capacity of 1.0 J/gC°.

22. A method according to claim 1, further comprising the step of heat curing the air-bag after the or each said bubble has burst.

23. An air-bag when sealed by a method according to claim 1.
